(19) United States
(12) Patent Application Publication
(10) Pub. No.: US 2025/0383203 A1
(43) Pub. Date: Dec. 18, 2025

(54) IN-PLANE DISPLACEMENT DETECTION STRUCTURE AND ACCELEROMETER

(71) Applicant: AAC Kaitai Technologies (Wuhan) CO., LTD., Wuhan (CN)

(72) Inventors: Lingcheng Kong, Wuhan (CN); Shitao Yan, Wuhan (CN); Zhan Zhan, Wuhan (CN); Xiao Kan, Wuhan (CN); Shan Yang, Wuhan (CN); Zhao Ma, Wuhan (CN); Yang Li, Wuhan (CN); Kahkeen Lai, Singapore (SG); Qiuyu Tan, Singapore (SG)

(21) Appl. No.: 19/000,624

(22) Filed: Dec. 23, 2024

Related U.S. Application Data
(63) Continuation of application No. PCT/CN2024/098616, filed on Jun. 12, 2024.

(51) Int. Cl. G01C 19/5733

(52) U.S. Cl. CPC G01C 19/5733

(57) ABSTRACT

An in-plane displacement detection structure and an accelerometer are provided. The in-plane displacement detection structure includes a substrate, a detection assembly disposed on the substrate, and electrode wires. The detection assembly includes two first detection assemblies. The two first detection assemblies are centrosymmetric with each other. Each of the first detection assemblies includes a first movable plate, a first fixed plate, a second fixed plate, and a second movable plate that are sequentially disposed at intervals. Each second fixed plate and each second movable plate are stepped. Two second movable plates thereof are adjacent to each other. Each of the electrode wires is electrically connected to first electrode anchor points and second electrode anchor points of the detection assembly. In the in-plane displacement detection structure, a space occupied by fixed plates and movable plates is reduced to make it suitable for a miniaturized design of the accelerometer.

### TECHNICAL FIELD

The present disclosure relates to a technical field of displacement detection, and in particular to an in-plane displacement detection structure and an accelerometer.

### BACKGROUND

Accelerometers are an instrument configured to measure a magnitude of acceleration or a magnitude of angular acceleration. Accelerometers are divided into piezoelectric accelerometers, capacitive accelerometers, and thermal induction accelerometers. The capacitive accelerometers use an arrangement with fixed teeth (fixed plates) and movable teeth (movable plates), so that when a device is displaced by in-plane acceleration, a distance between the fixed plates and the movable plates changes, resulting in a change in capacitance, which is configured to infer a magnitude of the acceleration or a magnitude of the angular acceleration.

In the related art, as shown in FIGS. 1-3, an in-plane displacement detection structure 100 of an accelerometer comprises fixed plates 101, movable plates 102, and electrode wires 104. The fixed plates 101 and the movable plates 102 are disposed at intervals. The electrode wires 104 are electrically connected to electrode anchor points 103 on the fixed plates. Since the movable plates 102 disposed between two adjacent fixed plates 101 are flat plate structures, and in order to make room for the electrode anchor points 103, an arrangement of the fixed plates 101 and the movable plates 102 occupies a large amount of space, making the in-plane displacement detection structure 100 unsuitable for a miniaturized design of the accelerometer.

Therefore, it is necessary to provide an improved in-plane displacement detection structure to solve above problems.

### SUMMARY

A purpose of the present disclosure is to provide an in-plane displacement detection structure and an accelerometer to solve a problem that an arrangement of fixed plates and movable plates in an in-plane displacement detection structure of an accelerometer in the related art occupies a large amount of space.

In a first aspect, the present disclosure provides an in-plane displacement detection structure. The in-plane displacement detection structure comprises a substrate, a detection assembly disposed on the substrate, and electrode wires configured to electrically connected to the detection assembly.

The detection assembly comprises two first detection assemblies. The two first detection assemblies are centrosymmetric with each other. Each of the first detection assemblies comprises a first movable plate, a first fixed plate, a second fixed plate, and a second movable plate.

The first movable plate, the first fixed plate, the second fixed plate, and the second movable plate of each of the first detection assemblies extend in a first direction and are sequentially disposed at intervals in a second direction. Each first fixed plate and each second fixed plate are fixed to the substrate. Each first movable plate and each second movable plate are respectively suspended above the substrate by elastic suspension beams. The elastic suspension beam only deform in the second direction, and the first direction is perpendicular to the second direction.

Each first movable plate is in a flat plate shape.

Each first fixed plate comprises a first fixed plate body and a first electrode anchor point. The first fixed plate body of each first fixed plate is in a flat plate shape and is opposite to a corresponding movable plate. The first fixed plate body of each first fixed plate protrudes and extends in a direction away from the first movable plate of each of the first detection assemblies to from the first electrode anchor point of each first fixed plate.

Each second fixed plate is stepped. Each second fixed plate comprises a second fixed plate body, a second electrode anchor point, and a fixed plate extension body. Each second fixed plate body is in a flat plate shape and is spaced apart from a corresponding first fixed plate body. Each second fixed plate body directly faces the corresponding first fixed plate body. One end of each second fixed plate body close to a corresponding first electrode anchor point protrudes and extends to form the second electrode anchor point of each second fixed plate. Each fixed plate extension body protrudes and extends from one side of a corresponding second electrode anchor point away from a corresponding second fixed plate body. Each second electrode anchor point extends in a direction away from a corresponding first movable plate. Each fixed plate extension body extends in the first direction away from the corresponding second fixed plate body, and each fixed plate extension body is in a flat plate shape. Each second electrode anchor point is staggered with a corresponding first electrode anchor point. An orthographic projection of each second electrode anchor point to the corresponding first electrode anchor point in the first direction partially falls within the corresponding first electrode anchor point. A distance between each fixed plate extension body and a corresponding first fixed plate body is greater than a distance between each second fixed plate body and the corresponding first fixed plate body in the second direction.

Each second movable plate and each second fixed plate are stepped structures. In the first direction, an orthographic projection of each second movable plate partially overlaps an orthographic projection of a corresponding second fixed plate.

Two second movable plates of the two first detection assemblies are disposed adjacent to each other. Each of the electrode wires is electrically connected to two first electrode anchor points and two second electrode anchor points of the detection assembly.

In one optional embodiment, each second movable plate comprises a second movable plate body, a movable plate bending section, and a movable plate extension body. Each second movable plate body is in a flat plate shape and directly faces a corresponding second fixed plate body. Each second movable plate body is spaced apart from the corresponding second fixed plate body. One end of each second movable plate body close to a corresponding second electrode anchor point protrudes and extends to form the movable plate bending section. One end of each second movable plate body away from a corresponding second movable plate body is bent and extended to form each movable plate extension body.

Each movable plate bending section extends away from a corresponding second fixed plate body in the second direction. Each movable plate extension body extends in the first direction away from a corresponding second movable plate body. Each movable plate extension body is in a flat plate shape. An orthographic projection of each movable plate bending section toward a corresponding second electrode anchor point in the first direction falls within the corresponding second electrode anchor point.

In one optional embodiment, each first electrode anchor point and each second electrode anchor point are respectively in a polygonal structure.

In one optional embodiment, a spacing distance between each second movable plate body and the corresponding second fixed plate body is equal to a spacing distance between each movable plate extension body and a corresponding fixed plate extension body.

In one optional embodiment, the detection assembly further comprises two second detection assemblies, the two second detection assemblies are disposed on the substrate and are centrosymmetric with each other. Structures of the two second detection assemblies are same as structures of the two first detection assemblies. Two second movable plates in the two second detection assemblies are disposed adjacent to each other.

In one optional embodiment, the two second movable plates of the two first detection assemblies disposed adjacent to each other and/or the two second movable plates of the two second detection assemblies disposed adjacent to each other are an integrated structure.

In one optional embodiment, two first movable plates of the two first detection assemblies disposed adjacent to each other and/or two first movable plates of the two second detection assemblies disposed adjacent to each other are an integrated structure.

In one optional embodiment, the two first detection assemblies and the two second detection assemblies are disposed in mirror symmetry with an axis parallel to the first direction as an axis.

In one optional embodiment, ends of the first movable plates in the first direction and ends of second movable plates located on a same side of the ends of first movable plates are connected together to form an integrally formed structure.

In as second aspect, the present disclosure provides an accelerometer. The accelerometer comprises the in-plane displacement detection structure mentioned above.

Compared with the related art, in the in-plane displacement detection structure of the present disclosure, the two first detection assemblies are centrosymmetric with each other, each of the second moving plate and the second fixed plate of each of the first detection assemblies are configured as a stepped structure, and the two second moving plates of the two first detection assemblies are disposed adjacent to each other. In this way, in the in-plane displacement detection structure, a space occupied by an arrangement of the fixed plates and the moving plates is reduced without affecting gain of a detection capacitor, so that the in-plane displacement detection structure is suitable for a miniaturized design of the accelerometer.

### BRIEF DESCRIPTION OF DRAWINGS

In order to clearly describe technical solutions in the embodiments of the present disclosure, the following will briefly introduce the drawings that need to be used in the description of the embodiments or the related art. Apparently, the drawings in the following description are merely some of the embodiments of the present disclosure, and those skilled in the art are able to obtain other drawings according to the drawings without contributing any inventive labor.

FIG. 1 is a perspective schematic diagram of a first embodiment of an in-plane displacement detection structure in the related art.

FIG. 2 is a cross-sectional schematic diagram of the first embodiment of the in-plane displacement detection structure in the related art

FIG. 3 is a cross-sectional schematic diagram of a second embodiment of the in-plane displacement detection structure in the related art

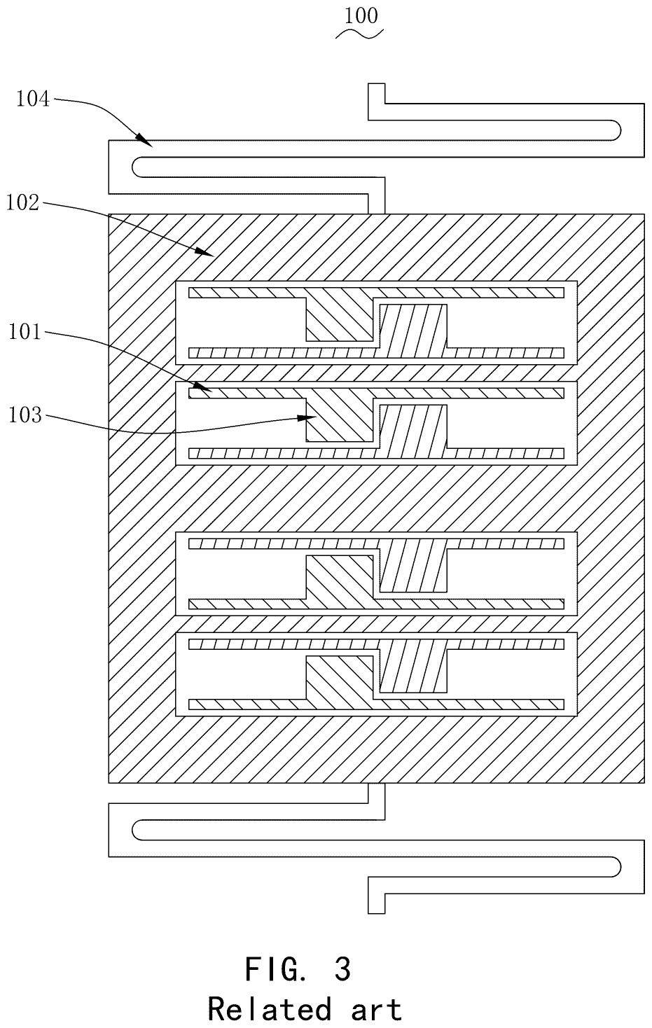

FIG. 4 is a cross-sectional schematic diagram of a first embodiment of an in-plane displacement detection structure of the present disclosure.

FIG. 5 is a cross-sectional schematic diagram of a second embodiment of the in-plane displacement detection structure of the present disclosure.

FIG. 6 is a schematic diagram of the second embodiment of the in-plane displacement detection structure in the related art and the second embodiment of the in-plane displacement detection structure of the present disclosure, where (a) is a schematic diagram of the second embodiment of the in-plane displacement detection structure in the related art and (b) is a schematic diagram of the second embodiment of the in-plane displacement detection structure of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

### Embodiment 1

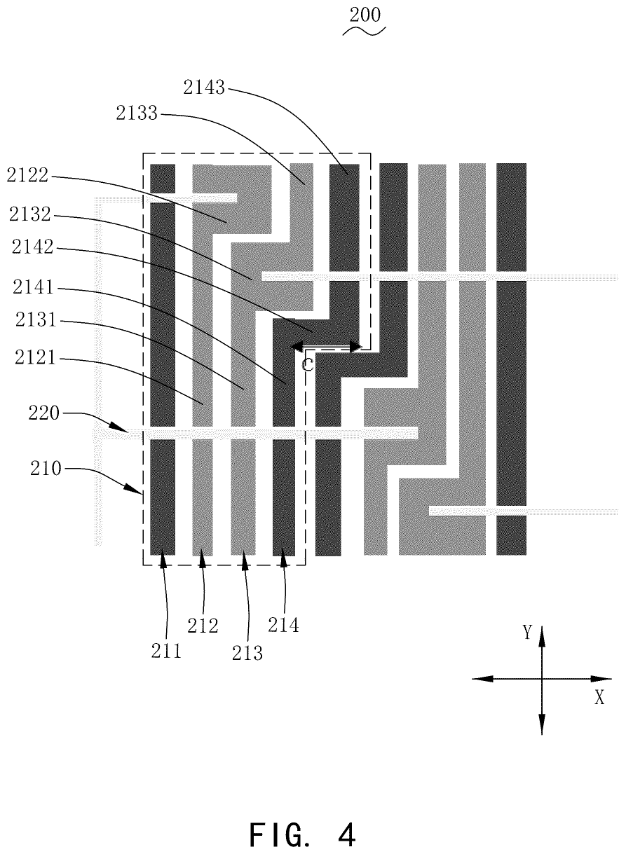

The embodiment of the present disclosure provides an in-plane displacement detection structure 200. As shown in FIG. 4, the in-plane displacement detection structure 200 comprises a substrate (not shown), a detection assembly disposed on the substrate, and electrode wires 220 configured to electrically connected to the detection assembly.

The detection assembly comprises two first detection assemblies 210. The two first detection assemblies 210 are centrosymmetric with each other. Each of the first detection assemblies 210 comprises a first movable plate 211, a first fixed plate 212, a second fixed plate 213, and a second movable plate 214. The first movable plate 211, the first fixed plate 212, the second fixed plate 213, and the second movable plate 214 of each of the first detection assemblies 210 extend in a first direction and are sequentially disposed at intervals in a second direction. Each first fixed plate 212 and each second fixed plate 213 are fixed to the substrate. Each first movable plate 211 and each second movable plate 214 are respectively suspended above the substrate by elastic suspension beams. The elastic suspension beam only deform in the second direction. The first direction is perpendicular to the second direction. The first direction is a Y-axis direction, and the second direction is an X-axis direction.

Each first movable plate 211 is in a flat plate shape.

Each first fixed plate 212 comprises a first fixed plate body 2121 and a first electrode anchor point 2122. The first fixed plate body 2121 of each first fixed plate 212 is in a flat plate shape and is opposite to a corresponding movable plate. The first fixed plate body 2121 of each first fixed plate 212 protrudes and extends in a direction away from the first movable plate 211 of each of the first detection assemblies 210 to from the first electrode anchor point 2122 of each first fixed plate 212.

Each second fixed plate 213 is stepped. Each second fixed plate 213 comprises a second fixed plate body 2131, a second electrode anchor point 2132, and a fixed plate extension body 2133. Each second fixed plate body 2131 is in a flat plate shape and is spaced apart from a corresponding first fixed plate body 2121. Each second fixed plate body 2131 directly faces the corresponding first fixed plate body 2121. One end of each second fixed plate body 2131 close to a corresponding first electrode anchor point 2122 protrudes and extends to form the second electrode anchor point 2132 of each second fixed plate 213. Each fixed plate extension body 2133 protrudes and extends from one side of a corresponding second electrode anchor point 2132 away from a corresponding second fixed plate body 2131. Each second electrode anchor point 2132 extends in a direction away from a corresponding first movable plate 211. Each fixed plate extension body 2133 extends in the first direction away from the corresponding second fixed plate body 2131, and each fixed plate extension body 2133 is in a flat plate shape. Each second electrode anchor point 2132 is staggered with a corresponding first electrode anchor point 2122. An orthographic projection of each second electrode anchor point 2132 to the corresponding first electrode anchor point 2122 in the first direction partially falls within the corresponding first electrode anchor point 2122. A distance between each fixed plate extension body 2133 and a corresponding first fixed plate body 2121 is greater than a distance between each second fixed plate body 2131 and the corresponding first fixed plate body 2121 in the second direction.

Each second movable plate 214 and each second fixed plate 213 are stepped structures. In the first direction, an orthographic projection of each second movable plate 214 partially overlaps an orthographic projection of a corresponding second fixed plate 213.

Specifically, each second movable plate 214 comprises a second movable plate body 2141, a movable plate bending section 2142, and a movable plate extension body 2143. Each second movable plate body 2141 is in a flat plate shape and directly faces a corresponding second fixed plate body 2131. Each second movable plate body 2141 is spaced apart from the corresponding second fixed plate body 2131. One end of each second movable plate body 2141 close to a corresponding second electrode anchor point 2132 protrudes and extends to form the movable plate bending section 2142. One end of each second movable plate body 2141 away from a corresponding second movable plate body 2141 is bent and extended to form each movable plate extension body 2143. Each movable plate bending section 2142 extends away from a corresponding second fixed plate body 2131 in the second direction. Each movable plate extension body 2143 extends in the first direction away from a corresponding second movable plate body 2141. Each movable plate extension body 2143 is in a flat plate shape. An orthographic projection of each movable plate bending section 2142 toward a corresponding second electrode anchor point 2132 in the first direction falls within the corresponding second electrode anchor point 2132.

Two second movable plates 214 of the two first detection assemblies 210 are disposed adjacent to each other. Each of the electrode wires 220 is electrically connected to two first electrode anchor points 2122 and two second electrode anchor point s2132 of the detection assembly.

In the embodiment, each of the electrode wires 220 is electrically connected to the first electrode anchor point 2122 of one of the two first detection assemblies 210 and the second electrode anchor point 2132 of the other one of the two first detection assemblies 210, and all of the electrode wires 220 are formed by extending outward from a common connecting point.

In the embodiment, each first electrode anchor point 2122 and each second electrode anchor point 2132 are respectively in a polygonal structure. That is, each first electrode anchor point 2122 and each second electrode anchor point 2132 may be designed into other shapes, such as a cuboid, a square, a trapezoid, etc.

In the embodiment, a spacing distance between each second movable plate body 2141 and the corresponding second fixed plate body 2131 is equal to a spacing distance between each movable plate extension body 2143 and a corresponding fixed plate extension body 2133. Through such design, a space occupied by the arrangement of fixed plates and movable plates is further reduced. That is, the space occupied by the in-plane displacement detection structure 200 along the Y-axis direction is reduced.

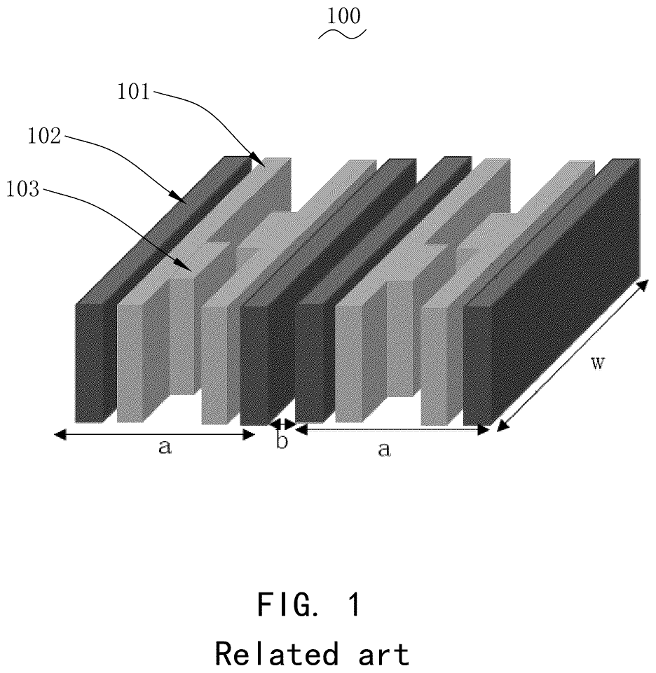

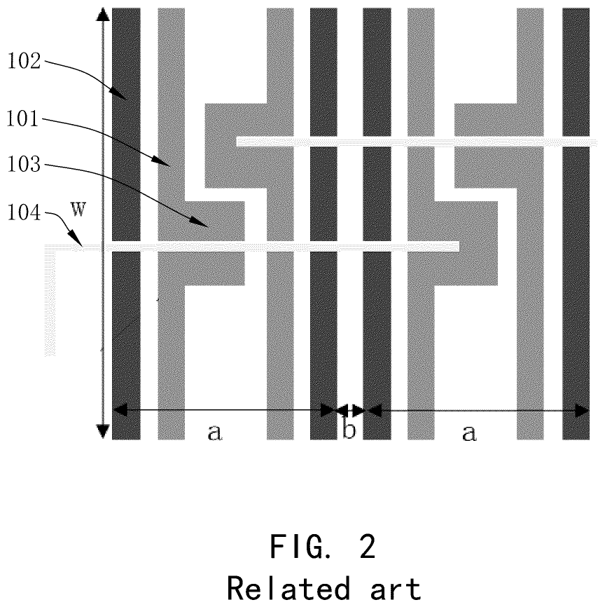

Specifically, an arrangement of fixed plates 101 and movable plates 102 in an in-plane displacement detection structure 100 of the related art is shown in FIG. 1, and an arrangement of electrode wires 104 thereof is shown in FIG. 2. That is, electrode anchor points 103 on the fixed plates 101 of the same potential are electrically connected together for testing. When the movable plates 102 are subjected to an external load (acceleration or angular velocity) in a Y-axis direction thereof and move to generate displacement, a distance between the fixed plates 101 and the movable plates 102 changes, causing a capacitance thereof to change. By testing change in the capacitance, a magnitude of an acceleration or a magnitude of the angular acceleration in the Y-axis direction is inferred to realize testing, and a test in the X-axis direction is performed similarly.

An occupied area of the in-plane displacement detection structure 100 in the related art is A1=w*(2a+b). By the specific design, in the in-plane displacement detection structure 200 of the embodiment, middle parts between two adjacent second movable plates 214 overlap, and an overlapping part thereof is c, so an occupied area of the in-plane displacement detection structure 200 is A2=w*[(2a−c)+b], Compared with the in-plane displacement detection structure 100 in the related art, an area percentage saved by the in-plane displacement detection structure 200 in the embodiment is: (A1−A2)/A2=(w*(2a+b)−w*[(2a−c)+b])/w*[(2a−c)+b]=c/[(2a−c)+b]. For example, if a=20 μm, b=5 μm, c=10 μm, and according to the formulas, it is obtained that the area percentage saved by the in-plane displacement detection structure 200 in the embodiment is 28.6%.

In the in-plane displacement detection structure 200 of the present disclosure, the two first detection assemblies 210 are centrosymmetric with each other, each of the second moving plate and the second fixed plate 213 of each of the first detection assemblies 210 are configured as a stepped structure, and the two second moving plates of the two first detection assemblies 210 are disposed adjacent to each other. In this way, in the in-plane displacement detection structure 200, a space occupied by an arrangement of the fixed plates and the moving plates is reduced without affecting gain of a detection capacitor, so that the in-plane displacement detection structure 200 is suitable for a miniaturized design of the accelerometer.

### Embodiment 2

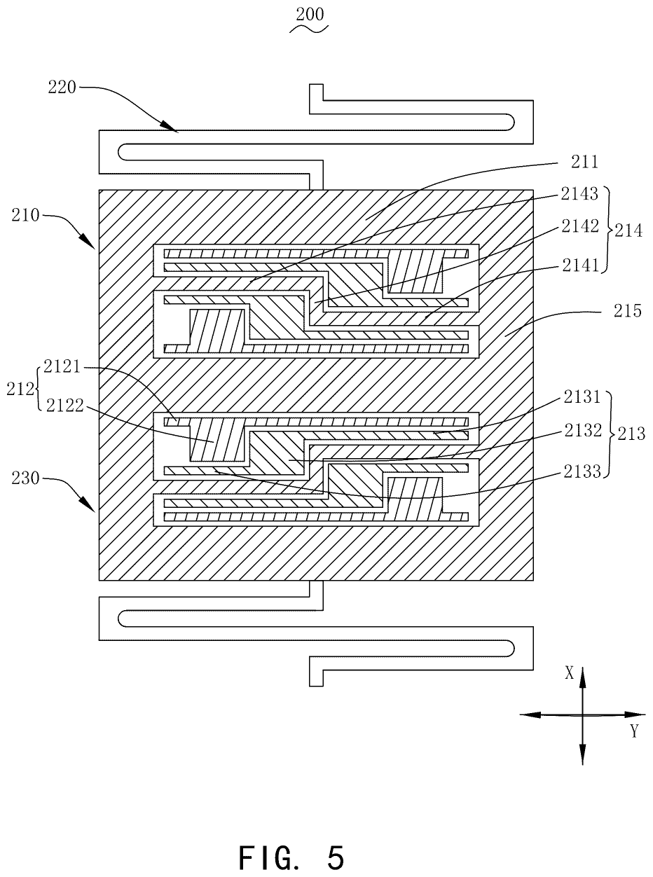

As shown in FIG. 5, the embodiment of the present disclosure provides an in-plane displacement detection structure 200. The only difference between the embodiment and the embodiment 1 is that the detection assembly further comprises two second detection assemblies 230. The two second detection assemblies 230 are disposed on the substrate and are centrosymmetric with each other. Structures of the two second detection assemblies 230 are same as structures of the two first detection assemblies 210. Two second movable plates in the two second detection assemblies 230 are disposed adjacent to each other.

Specifically, the two first detection assemblies 210 and the two second detection assemblies 230 are disposed in mirror symmetry with an axis parallel to the first direction as an axis.

The two second movable plates 214 disposed adjacent to each other of the two first detection assemblies 210 and/or the two second movable plates 214 disposed adjacent to each other of the two second detection assemblies 230 are an integrated structure. That is, the two second movable plates 214 of the two first detection assemblies 210 disposed adjacent to each other shares a same second movable plate 214, so as to reduce the space occupied by the arrangement of the fixed plates and the movable plates.

Ends of the first movable plates 211 in the first direction and ends of second movable plates located on a same side of the ends of first movable plates are connected together to form an integrally formed structure. That is, the ends of the four first moving plates 211 and the ends of the four second moving plates 214, disposed on the same side, of the detection assembly, are respectively connected by two connectors 215, so that the four first moving plates 211 and the four second moving plates 214 of the detection assembly 210 form the integrally formed structure. By such design, the space occupied by the arrangement of the fixed plates and the moving plates is further reduced.

The two first movable plates of the two first detection assemblies 210 disposed adjacent to each other and/or the two first movable plates of the two second detection assemblies 230 disposed adjacent to each other are an integrated structure.

That is, the first detection assemblies 210 disposed adjacent to each other and/or the two second detection assemblies 230 disposed adjacent to each other share a same first moving plate 211. By such design, the space occupied by the arrangement of the fixed plates and the moving plates is further reduced.

Since the second detection assemblies 230 have the same structures as the first detection assemblies 210, the reference numbers of the second detection assemblies 230 are the same as that in the first detection assemblies 210.

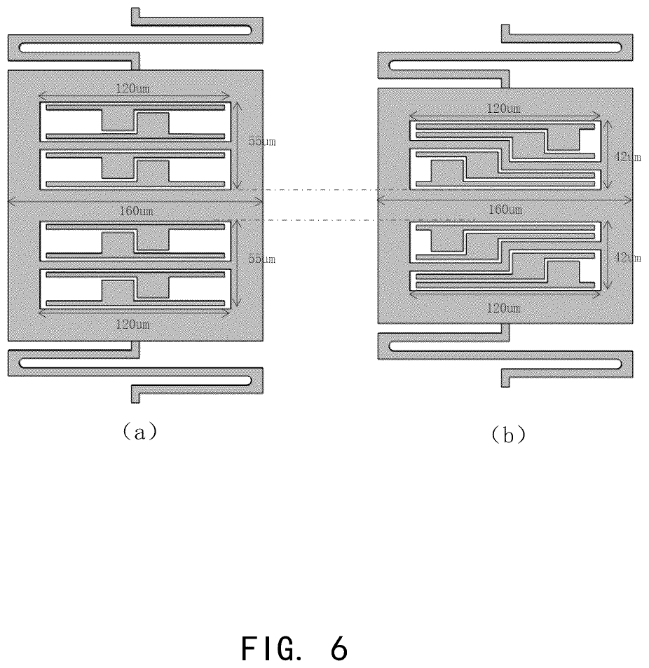

Specifically, length markings of the in-plane displacement detection structure 100 of the related art and the in-plane displacement detection structure 200 of the embodiment are shown in FIG. 6. By comparison, it is noted that that the area of the in-plane displacement detection structure 200 of the embodiment along the Y-axis direction saves 2*160*(55−42)=4160 um² and the gain thereof is unchanged.

### Embodiment 3

The embodiment of the present disclosure provides an accelerometer. The accelerometer comprises the in-plane displacement detection structure 200 in the above-mentioned embodiment 1 or embodiment 2.

Since the accelerometer in the embodiment comprises the in-plane displacement detection structure 200 in the embodiment 1 or the embodiment 2, the accelerometer also realize technical effects realized by the in-plane displacement detection structure 200 in the embodiment 1 or the embodiment 2, which are not repeatedly illustrated herein.

The above are only the embodiments of the present disclosure. It should be pointed out that for those of ordinary skill in the art, improvements can be made without departing from the inventive concept of the present disclosure, and these improvements fall within the protection scope of the present disclosure.

What is claimed is:

1. An in-plane displacement detection structure, comprising
a substrate;
a detection assembly disposed on the substrate; and
electrode wires configured to electrically connected to the detection assembly;
wherein the detection assembly comprises two first detection assemblies, the two first detection assemblies are centrosymmetric with each other, and each of the first detection assemblies comprises a first movable plate, a first fixed plate, a second fixed plate, and a second movable plate;
wherein the first movable plate, the first fixed plate, the second fixed plate, and the second movable plate of each of the first detection assemblies extend in a first direction and are sequentially disposed at intervals in a second direction, each first fixed plate and each second fixed plate are fixed to the substrate, each first movable plate and each second movable plate are respectively suspended above the substrate by elastic suspension beams, the elastic suspension beam only deform in the second direction, and the first direction is perpendicular to the second direction;
wherein each first movable plate is in a flat plate shape;
wherein each first fixed plate comprises a first fixed plate body and a first electrode anchor point, the first fixed plate body of each first fixed plate is in a flat plate shape and is opposite to a corresponding movable plate, the first fixed plate body of each first fixed plate protrudes and extends in a direction away from the first movable plate of each of the first detection assemblies to from the first electrode anchor point of each first fixed plate;
wherein each second fixed plate is stepped, each second fixed plate comprises a second fixed plate body, a second electrode anchor point, and a fixed plate extension body; wherein each second fixed plate body is in a flat plate shape and is spaced apart from a corresponding first fixed plate body, each second fixed plate body directly faces the corresponding first fixed plate body, one end of each second fixed plate body close to a corresponding first electrode anchor point protrudes and extends to form the second electrode anchor point of each second fixed plate, each fixed plate extension body protrudes and extends from one side of a corresponding second electrode anchor point away from a corresponding second fixed plate body, each second electrode anchor point extends in a direction away from a corresponding first movable plate, each fixed plate extension body extends in the first direction away from the corresponding second fixed plate body, and each fixed plate extension body is in a flat plate shape, each second electrode anchor point is staggered with a corresponding first electrode anchor point, an orthographic projection of each second electrode anchor point to the corresponding first electrode anchor point in the first direction partially falls within the corresponding first electrode anchor point, and a distance between each fixed plate extension body and a corresponding first fixed plate body is greater than a distance between each second fixed plate body and the corresponding first fixed plate body in the second direction;
wherein each second movable plate and each second fixed plate are stepped structures, and in the first direction, an orthographic projection of each second movable plate partially overlaps an orthographic projection of a corresponding second fixed plate;
wherein two second movable plates of the two first detection assemblies are disposed adjacent to each other, and each of the electrode wires is electrically connected to two first electrode anchor points and two second electrode anchor points of the detection assembly.

2. The in-plane displacement detection structure according to claim 1, wherein each second movable plate comprises a second movable plate body, a movable plate bending section, and a movable plate extension body; wherein each second movable plate body is in a flat plate shape and directly faces a corresponding second fixed plate body, each second movable plate body is spaced apart from the corresponding second fixed plate body, one end of each second movable plate body close to a corresponding second electrode anchor point protrudes and extends to form the movable plate bending section, and one end of each second movable plate body away from a corresponding second movable plate body is bent and extended to form each movable plate extension body;
wherein each movable plate bending section extends away from a corresponding second fixed plate body in the second direction, each movable plate extension body extends in the first direction away from a corresponding second movable plate body, each movable plate extension body is in a flat plate shape; and an orthographic projection of each movable plate bending section toward a corresponding second electrode anchor point in the first direction falls within the corresponding second electrode anchor point.

3. The in-plane displacement detection structure according to claim 1, wherein each first electrode anchor point and each second electrode anchor point are respectively in a polygonal structure.

4. The in-plane displacement detection structure according to claim 2, wherein a spacing distance between each second movable plate body and the corresponding second fixed plate body is equal to a spacing distance between each movable plate extension body and a corresponding fixed plate extension body.

5. The in-plane displacement detection structure according to claim 1, wherein the detection assembly further comprises two second detection assemblies, the two second detection assemblies are disposed on the substrate and are centrosymmetric with each other, structures of the two second detection assemblies are same as structures of the two first detection assemblies, and two second movable plates in the two second detection assemblies are disposed adjacent to each other.

6. The in-plane displacement detection structure according to claim 5, wherein the two second movable plates of the two first detection assemblies disposed adjacent to each other and/or the two second movable plates of the two second detection assemblies disposed adjacent to each other are an integrated structure.

7. The in-plane displacement detection structure according to claim 5, wherein two first movable plates of the two first detection assemblies disposed adjacent to each other and/or two first movable plates of the two second detection assemblies disposed adjacent to each other are an integrated structure.

8. The in-plane displacement detection structure according to claim 6, wherein the two first detection assemblies and the two second detection assemblies are disposed in mirror symmetry with an axis parallel to the first direction as an axis.

9. The in-plane displacement detection structure according to claim 7, wherein the two first detection assemblies and the two second detection assemblies are disposed in mirror symmetry with an axis parallel to the first direction as an axis.

10. The in-plane displacement detection structure according to claim 5, wherein ends of first movable plates in the first direction and ends of second movable plates located on a same side of the ends of first movable plates are connected together to form an integrally formed structure.

11. The in-plane displacement detection structure according to claim 6, wherein ends of first movable plates in the first direction and ends of the second movable plates located on a same side of the ends of first movable plates are connected together to form an integrally formed structure.

12. The in-plane displacement detection structure according to claim 7, wherein ends of the first movable plates in the first direction and ends of second movable plates located on a same side of the ends of first movable plates are connected together to form an integrally formed structure.

13. An accelerometer, comprising: the in-plane displacement detection structure according to claim 1.
